(19) United States
(12) Patent Application Publication
(10) Pub. No.: US 2007/0297014 A1
(43) Pub. Date: Dec. 27, 2007

(54) IMAGE PROCESSING SYSTEM AND IMAGE PROCESSING METHOD

(76) Inventors: Takeshi Kuga, Tokyo (JP); Shigeru Fujita, Kanagawa-ken (JP); Hiroki Horikoshi, Kanagawa-ken (JP); Akira Ichimura, Tokyo (JP); Hideki Takemura, Tokyo (JP); Hiroyuki Hosogoshi, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/763,513

(22) Filed: Jun. 15, 2007

(30) Foreign Application Priority Data
Jun. 23, 2006 (JP) 2006-174452

(51) Int. Cl. G06K 9/00

(52) U.S. Cl. 358/3.28; 382/100

(57) ABSTRACT

There is provided an image processing system in which a management server, a host computer, and a printer are connected via a network, and said host computer prints image data received from said management server based on a printing parameter indicating a printing condition set by a user using said printer, wherein said host computer receives image data appended with a visible digital watermark from said management server, detects a printing parameter set in said printer, collates the detected printing parameter with a limited parameter which is set in advance for the image data, and removes the visible digital watermark from the image data in accordance with the collation result.

### BACKGROUND OF THE INVENTION

1. Field of the Invention

The present invention relates to an image processing system and image processing method and, more particularly, to an image processing system and image processing method, which print out a copyright image or the like under an ideal printing condition.

2. Description of the Related Art

In recent years, along with the prevalence of network technologies, digital data are distributed smoothly. Under such circumstances, markets that merchandise valuable image data such as copyright images and the like are expanded.

As marketing systems of digital contents, a system that charges a fee every time an image is printed is known. In such a system, as a method of purchasing a digital content by the user, a method of directly purchasing the digital content by the user via a network, a method of indirectly purchasing the digital content when the user requests a print service to print it, and the like are available.

In the marketing systems of digital contents, images of commercial values are handled as commercial articles, and such images must be printed out with settings that reflect the intentions of copyright holders such as painters, photographers, and the like. For example, when conditions such as the print resolution, inks, media, image size, and the like do not match the those intended by the copyright holders, the values as their works are violated.

In order to solve such problems, Japanese Patent Laid-Open No. 2004-348613 has proposed a system which checks if the user has a system environment suited to use a digital content upon purchasing the digital content.

However, in the system that checks the user's system environment upon purchasing the digital content, the following problem still remains unsolved. For example, when the user purchases a digital content, since he or she can print that digital content irrespective of settings after the purchase, a printed image that the copyright holder did not intend may be created.

### SUMMARY OF THE INVENTION

The present invention provides an image processing system and image processing method, which can reliably print image data under ideal printing conditions.

According to one aspect of the present invention, an image processing system in which a management server, a host computer, and a printer are connected via a network, and the host computer prints image data received from the management server based on a printing parameter indicating a printing condition set by a user using the printer, wherein the host computer receives image data appended with a visible digital watermark from the management server, detects a printing parameter set in the printer, collates the detected printing parameter with a limited parameter which is set in advance for the image data, and removes the visible digital watermark from the image data in accordance with a collation result.

According to another aspect of the present invention, an image processing system in which a management server, a host computer, and a printer are connected via a network, and the host computer prints image data received from the management server based on a printing parameter indicating a printing condition set by a user using the printer, wherein the host computer receives image data appended with a visible digital watermark from the management server, detects a printing parameter set in the printer, and sends the detected printing parameter to the management server, the management server collates the printing parameter received from the host computer with a limited parameter which is set in advance for the image data, and transmits a public key required to remove the visible digital watermark to the host computer in accordance with a collation result, and the host computer removes the visible digital watermark from the image data using the public key received from the management server.

According to still another aspect of the present invention, an image processing method for printing image data based on a printing parameter indicating a printing condition set by a user, the image processing method includes the steps of inputting image data appended with a visible digital watermark, detecting the printing parameter, collating the detected printing parameter with a limited parameter which is set in advance for the image data, and removing the visible digital watermark from the image data in accordance with a collation result.

Further features of the present invention will become apparent from the following description of exemplary embodiments with reference to the attached drawings.

### BRIEF DESCRIPTION OF THE DRAWINGS

FIG. 1 is a block diagram showing the arrangement of a digital content management system according to the first embodiment.

FIG. 2A is a view of an example of a copyright image according to the first embodiment.

FIG. 2B is a view of an example in which a visible digital watermark is embedded in the copyright image shown in FIG. 2A.

FIG. 3 is a flowchart showing print processing of a copyright image according to the first embodiment.

FIG. 4A is a view of an example of a copyright image according to the second embodiment.

FIG. 4B is a view of an example in which a visible digital watermark is embedded in the copyright image shown in FIG. 4A.

FIG. 5 is a flowchart showing print processing of a copyright image according to the second embodiment.

FIG. 6 is a view of a print example of the copyright image according to the second embodiment.

FIG. 7 is a block diagram showing the arrangement of a digital content management system according to the third embodiment.

FIG. 8 is a chart showing the processing sequence when printing parameters match in the third embodiment.

FIG. 9 is a chart showing the processing sequence when printing parameters do not match in the third embodiment.

### DESCRIPTION OF THE EMBODIMENTS

Preferred embodiments of the present invention will be described hereinafter with reference to the accompanying drawings. Note that the arrangements described in the embodiments to be described hereinafter are examples, and the present invention is not limited to the illustrated arrangements.

As the first embodiment, a case will be described below wherein the user purchases a digital content with a copyright in a system that markets digital contents.

In the first embodiment, a visible digital watermark is embedded in a digital content to be purchased, and when predetermined printing conditions are met at the purchase destination, the user at the purchase destination is permitted to print the purchased digital content while removing the visible digital watermark.

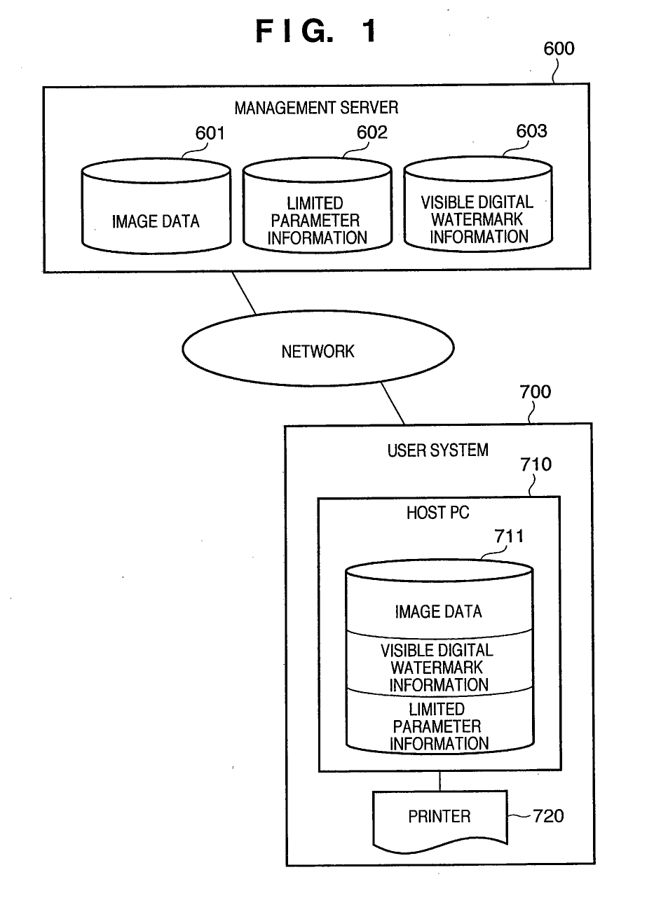

FIG. 1 is a block diagram showing the arrangement of a digital content management system that implements the first embodiment. Referring to FIG. 1, reference numeral 600 denotes a management server in a management center that sells copyrighted digital contents (to be referred to as copyright images hereinafter). Reference numeral 700 denotes a system used by the user (to be referred to as a user system hereinafter). Reference numeral 710 denotes a host PC used by the user. Reference numeral 720 denotes a printer. The management server 600 which sells copyright images and the host PC 710 used by the user are connected via a network such as the Internet or the like.

The management server 600 has a plurality of copyright images to be sold. More specifically, the management server 600 holds not only practical image data 601 corresponding to the plurality of copyright images, and limited parameter information 602 indicating ideal printing parameters according to the intention of each copyright holder, which are to be set upon printing a given copyright image. The limited parameter information 602 may be held in a format in which it is appended to the corresponding image data 601, i.e., in an identical file to the corresponding image data 601, or may be held in an independent file. Alternatively, the limited parameter information 602 may be embedded in the image data 601 as an invisible digital watermark. In this case, the limited parameter information 602 need not be held independently of images. The management server 600 also has visible digital watermark information 603 to be appended to the image data 601 upon selling a given copyright image.

When the user purchases a desired copyright image from those provided by the management server 600, a target copyright image 711 is downloaded from the management server 600 to the host PC 710. The copyright image 711 is transmitted in a format in which the visible digital watermark information 603 is embedded in the practical image data 601, and the limited parameter information 602 for that copyright image is appended.

The host PC 710 can print out the downloaded (purchased) copyright image 711 from the printer 720. In the first embodiment, whether or not the visible digital watermark is removed is determined according to settings of printing parameters in this case.

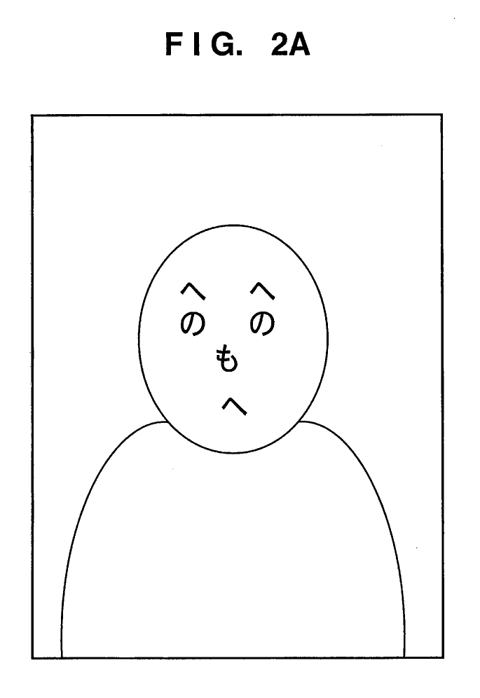

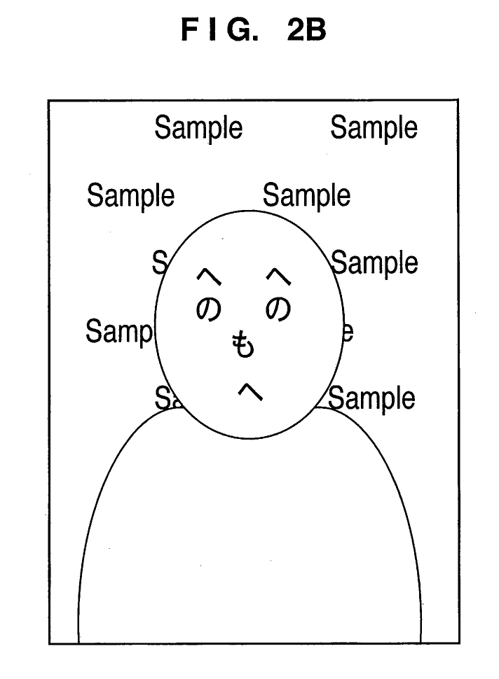

FIG. 2A is a view of an example of a copyright image before a visible digital watermark in the first embodiment is embedded. FIG. 2B is a view of an example of the copyright image after the visible digital watermark in the first embodiment is embedded. In other words, FIG. 2A shows an original image represented by the practical image data 601 of the copyright image. Referring to FIG. 2B, characters “Sample” indicated by the visible digital watermark information 603 are embedded in the background of a portrait as the original image shown in FIG. 2A. The image shown in FIG. 2B corresponds to the copyright image 711 downloaded to the host PC 710.

As described above, the copyright image 711 purchased at the host PC 710 is appended with the limited parameter information 602 indicating printing parameters that reflect the intention of the copyright holder. The practical contents (settings) of the printing parameters are as follows.

Image size: A1 to B0

Media: glossy photo paper

Ink: pigment

Printer resolution: 1200 dpi or higher

Print quality setting: high image quality

However, the above printing parameter settings are merely an example, and do not limit the present invention. Also, any other elements to be set according to the intention of the copyright holder may be set as the limited parameter information 602 as long as they can be checked upon printing.

In the first embodiment, when all printing parameters set upon printing the copyright image 711 purchased at the host PC 710 using the printer 720 match the contents indicated by the limited parameter information 602, the visible digital watermark is removed. In other words, in the first embodiment, only when all printing parameters meet required printing conditions in the printer 720, print processing can be executed while removing the visible digital watermark. Assume that the management server 600 provides the printing parameters to be set in the printer 720 to the user via the host PC 710 in, e.g., a format different from the image file of the copyright image.

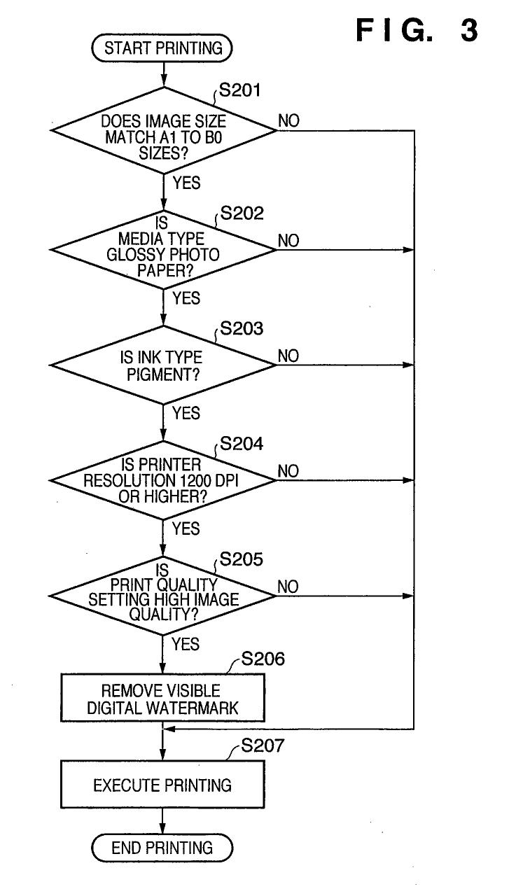

FIG. 3 is a flowchart showing the print processing of the copyright image 711 in the first embodiment. Upon issuance of a print instruction of the copyright image 711 purchased from the management server 600, the host PC 710 confirms the printing parameter settings in the printer 720 and executes print processing according to the confirmation result in accordance with the flowchart shown in FIG. 3.

The host PC 710 confirms the image size parameter in step S201 to check if the image size matches one of A1 to B0 sizes. If the image size matches one of A1 to B0 sizes, the process advances to step S202. The host PC 710 confirms the media type parameter in step S202 to check if the media type is glossy photo paper. If the media type is glossy photo paper, the process advances to step S203. The host PC 710 confirms the ink type parameter in step S203 to check if the ink type is “pigment”. If the ink type is “pigment”, the process advances to step S204. The host PC 710 confirms the printer resolution parameter in step S204 to check if the printer resolution is 1200 dpi or higher. If the printer resolution is 1200 dpi or higher, the process advances to step S205. The host PC 710 confirms the print quality setting parameter in step S205 to check if the print quality setting is high image quality setting. If the print quality setting is high image quality setting, the process advances to step S206.

In step S206, the host PC 710 removes the visible digital watermark embedded in the copyright image, as shown in FIG. 2B. Note that the removal method of the visible digital watermark information 603 from the image data 601 is known to those who are skilled in the art, and a detailed description thereof will not be made. In step S207, the host PC 710 executes print processing, so that the printer 720 prints out the copyright image shown in FIG. 2A with ideal settings.

If a mismatch of the condition is found in any of steps S201 to S205, the process jumps to step S207 to execute print processing. As a result, the host PC 710 does not remove the visible digital watermark, and the printer 720 prints out the image embedded with the visible digital watermark shown in FIG. 2B.

According to the first embodiment, upon printing the copyright image 711 purchased at the host PC 710, if at least one of the printing parameter settings is different from those which are set in the image in advance, an image embedded with a visible digital watermark is printed. Therefore, for example, even when the user expected to print an image with correct print settings, if a wrong print setting is included, he or she can easily notice such wrong print setting (error). In this manner, since the user can easily check if an appropriate print result is obtained for the purchased copyright image, high-image quality print processing that the copyright holder intended can be made.

The second embodiment will be described below. Since the system arrangement of the second embodiment is the same as that in the first embodiment, a repetitive description thereof will be avoided. In the second embodiment, the visible digital watermark information 603 is embedded in the image data 601 of the copyright image 711 purchased from the management server 600 as in the first embodiment, but the format of the visible digital watermark is different from that of the first embodiment.

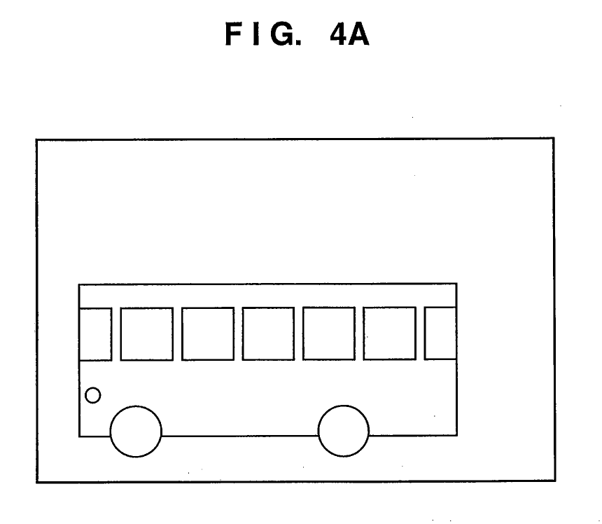

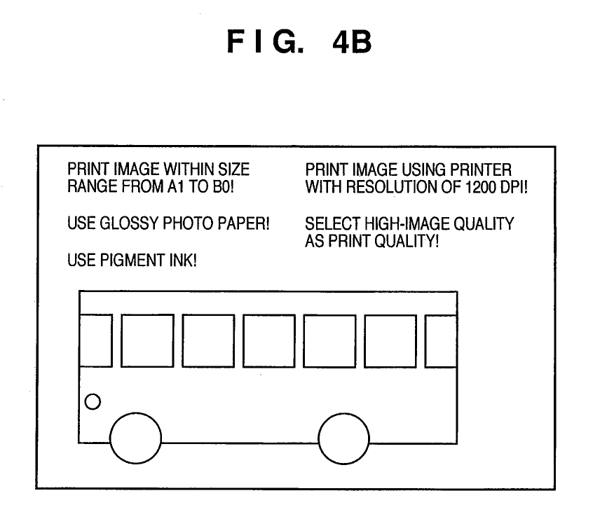

FIG. 4A is a view of an example of a copyright image before a visible digital watermark in the second embodiment is embedded. FIG. 4B is a view of an example of a copyright image after the visible digital watermark in the second embodiment is embedded. Referring to FIG. 4B, the visible digital watermark is embedded in the background of a bus image as the copyright image shown in FIG. 4A, as in the first embodiment. However, in the second embodiment, predetermined phrases are embedded as the visible digital watermark. The predetermined phrases are those which remind the user to adjust the current print environment in the host PC 710 to printing parameters that the copyright holder intended. With these phrases, the user can easily recognize printing parameters to be set in the printer 720 upon printing an image. The image shown in FIG. 4B corresponds to the copyright image 711 downloaded to the host PC 710.

Assume that the following phrases are set in the visible digital watermark information 603 as visible digital watermarks in the second embodiment.

Visible digital watermark A: “Print image within size range from A1 to B0!”

Visible digital watermark B: “Use glossy photo paper!”

Visible digital watermark C: “Use pigment ink!”

visible digital watermark D: “Print image using printer with resolution of 1200 dpi!”

visible digital watermark E: “Select high-image quality as print quality!”

Note that the same contents as in the first embodiment are set as the limited parameter information 602 in the second embodiment, and the phrases of the visible digital watermarks respectively indicate the contents corresponding to the printing parameters designated by the limited parameter information 602.

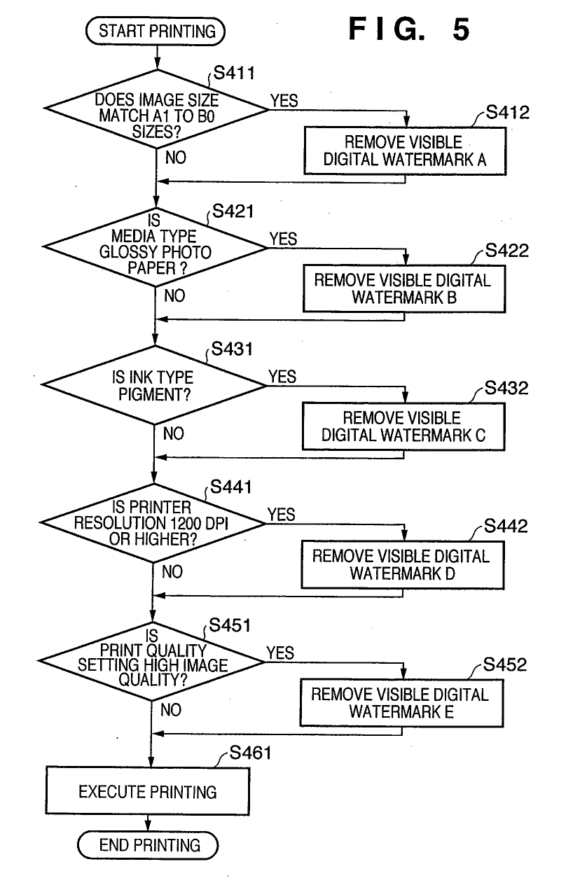

FIG. 5 is a flowchart showing the print processing of the copyright image 711 according to the second embodiment. In the second embodiment, only when all the printing parameters are correctly set in the printer 720, an image can be printed while removing the visible digital watermarks as in the first embodiment.

Upon issuance of a print instruction of the copyright image 711 purchased from the management server 600, the host PC 710 confirms the printing parameter settings in the printer 720 in accordance with the flowchart shown in FIG. 5.

The host PC 710 confirms the image size parameter in step S411 to check if the image size matches one of A1 to B0 sizes. If the image size matches one of A1 to B0 sizes, the process advances to step S412. The host PC 710 removes visible digital watermark A in step S412, and the process advances to step S421. On the other hand, if the image size does not match one of A1 to B0 sizes, the process advances to step S421 without removing visible digital watermark A.

The host PC 710 confirms the media type parameter in step S421 to check if the media type is glossy photo paper. If the media type is glossy photo paper, the process advances to step S422. The host PC 710 removes visible digital watermark B in step S422, and the process advances to step S431. On the other hand, if the media type is not glossy photo paper, the process advances to step S431 without removing visible digital watermark B.

The host PC 710 confirms the ink type parameter in step S431 to check if the ink type is “pigment”. If the ink type is “pigment”, the process advances to step S432. The host PC 710 removes visible digital watermark C in step S432, and the process advances to step S441. On the other hand, if the ink type is not “pigment”, the process advances to step S441 without removing visible digital watermark C.

The host PC 710 confirms the printer resolution parameter in step S441 to check if the printer resolution is 1200 dpi or higher. If the printer resolution is 1200 dpi or higher, the process advances to step S442. The host PC 710 removes visible digital watermark D in step S442, and the process advances to step S451. On the other hand, if the printer resolution is not 1200 dpi or higher, the process advances to step S451 without removing visible digital watermark D.

The host PC 710 confirms the print quality setting in step S451 to check if the print quality setting is high image quality setting. If the print quality setting is high image quality setting, the process advances to step S452. The host PC 710 removes visible digital watermark E in step S452, and the process advances to step S461. If the print quality setting is not high image quality setting, the process advances to step S461 without removing visible digital watermark E.

In step S461, the host PC 710 executes print processing. In this case, only when all the printing parameters match, the copyright image shown in FIG. 4A is printed out with ideal settings. In cases other than when all the printing parameters match, the copyright image is printed out with at least one visible digital watermark being embedded.

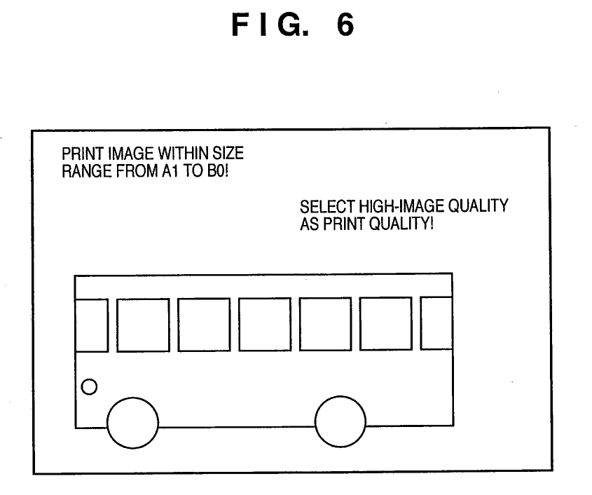

FIG. 6 shows an example of the copyright image printed out in the second embodiment. Referring to FIG. 6, compared to the image shown in FIG. 4B obtained by embedding all the visible digital watermarks in the original image shown in FIG. 4B, visible digital watermarks B, C, and D are removed, but visible digital watermarks A and E remain unremoved. This indicates that the media type, ink type, and printer resolution had ideal printing parameter settings, but the image size and print quality setting did not have ideal printing parameter settings upon printing the copyright image shown in FIG. 4A.

In the second embodiment, whether or not each of a plurality of printing parameters matches the setting that the copyright holder intended is confirmed, and the corresponding visible digital watermark is removed for the printing parameter of the match. Therefore, only when all the printing parameters match those that the copyright holder intended, all the visible digital watermarks are removed and the original image can be printed. On the other hand, for example, even when the user intended to print an image with correct print settings, if a wrong print setting is included, he or she can easily notice such wrong print setting (error), and can easily recognize its coping method. In other words, when the user glances at a printout embedded with the visible digital watermarks, he or she can easily determine printing parameters to be set to print out an original, high-quality image.

Therefore, when the user does not recognize ideal print settings (printing conditions) for the purchased copyright image, he or she can execute draft print processing with low image quality to recognize printing parameters to be set.

In the first and second embodiments, a region where the visible digital watermark is embedded is not limited to the background region shown in FIG. 2B or 4B. For example, when an important region in a image must be kept a secret, it is effective to embed a visible digital watermark in such important region (principal region).

In the flowcharts shown in FIGS. 3 and 5, a plurality of printing parameters are confirmed in turn. However, the order in which the parameters are to be confirmed is not limited, and they may be confirmed in any other orders.

The third embodiment will be described below. The first and second embodiments have exemplified the case in which ideal printing parameter information for the downloaded copyright image is appended to the copyright image as management data. However, when image data including the printing parameter information is sent, a new printing parameter cannot be flexibly coped with. For example, an already downloaded copyright image cannot cope with a new medium or new inks that can be used to print a higher-quality image. Hence, the third embodiment provides a digital content management system which can flexibly cope with new printing parameters.

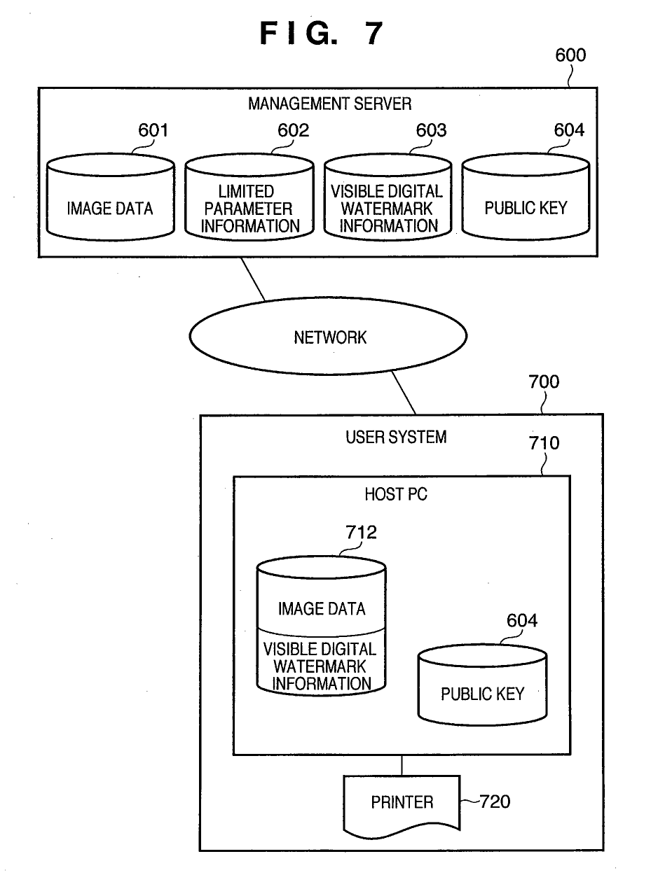

FIG. 7 is a block diagram showing the arrangement of a digital content management system that implements the third embodiment. Since the arrangement of the digital content management system shown in FIG. 7 is basically the same as that of the digital content management system shown in FIG. 1, the same reference numerals denote the same components, and a repetitive description thereof will be avoided. The digital content management system shown in FIG. 7 adopts a different data format of a copyright image 712 to be downloaded to the host PC 710 unlike in that shown in FIG. 1. In the digital content management system shown in FIG. 1, the copyright image 711 is transmitted while the visible digital watermark information 603 is embedded in the practical image data 602, and the limited parameter information 602 is appended. On the other hand, in the digital content management system shown in FIG. 7, the limited parameter information 602 is not appended to the copyright image 712. Assume that the contents indicated by the visible digital watermark information 603 in the third embodiment are the same as those in the first or second embodiment.

In the first and second embodiments, the host PC 710 checks whether or not the visible digital watermark is to be removed from the copyright image 711. However, in the third embodiment, the management server 600 checks whether or not the visible digital watermark is to be removed from the copyright image 712. The management server 600 transmits a public key 604 indicating the checking result to the host PC 710.

The processing sequence of the content management system of the third embodiment upon printing out the copyright image 712 that the host PC 710 purchased from the management server 600 using the printer 720 will be described below.

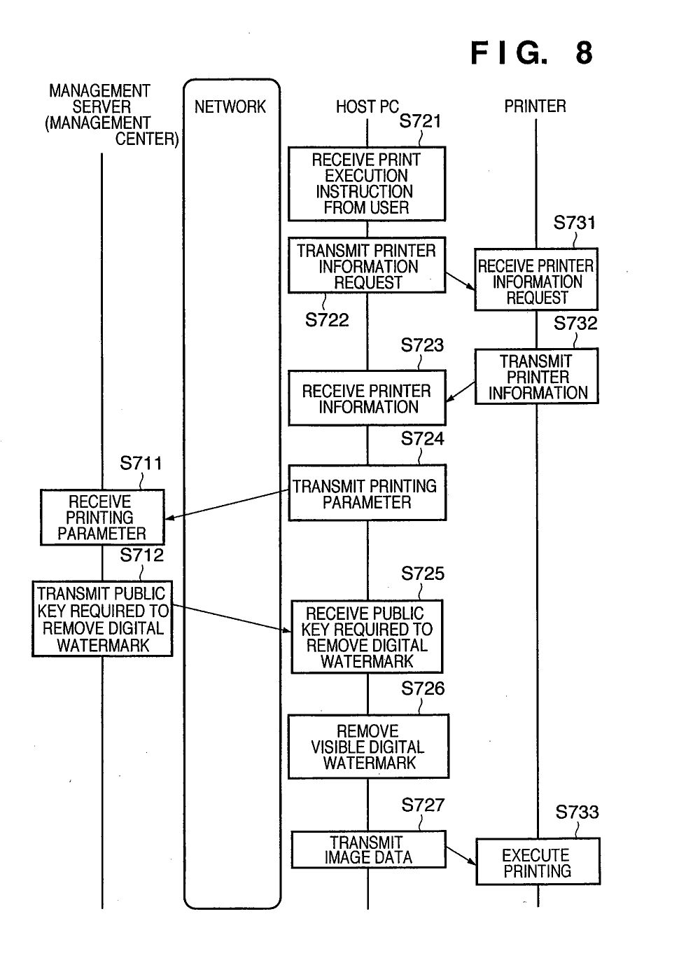

FIG. 8 shows the processing sequence executed when printing parameters set in the printer 720 match values which are pre-set for the copyright image 712, and print processing is executed while removing the visible digital watermark.

Upon reception of a print execution instruction from the user in step S721, the host PC 710 transmits a printer information request that requests to return printer information to the printer 720 in step S722. Upon reception of the printer information request from the host PC 710 in step S731, the printer 720 transmits the printer information to the host PC 710 in step S732. The host PC 710 receives the printer information from the printer 720 in step S723, and transmits printing parameters based on the printer information to the management server 600 in step S724.

Upon reception of the printing parameters in step S711, the management server 600 checks if the printing parameters match settings that the copyright holder intended. The management server 600 sequentially executes this checking processing for respective parameters with reference to the limited parameter information 602 of the copyright image as in the flowchart shown in FIG. 3. If all the printing parameters match the contents of the limited parameter information 602, the management server 600 permits execution of print processing of an original image. At this time, the management server 600 transmits a public key 604 required to remove the digital watermark to the host PC 710 in step S712.

Upon reception of the public key 604 from the management server 600 in step S725, the host PC 710 removes the visible digital watermark from the copyright image 712 using the public key 604 in step S726. In other words, the host PC 710 invalidates the visible digital watermark information 603 embedded in the image data 601 of the copyright image 712. The host PC 710 transmits the copyright image 712 from which the visible digital watermark is removed, i.e., only the image data 601 to the printer 720 in step S727. The printer 720 prints the image data received from the host PC 710 in step S733.

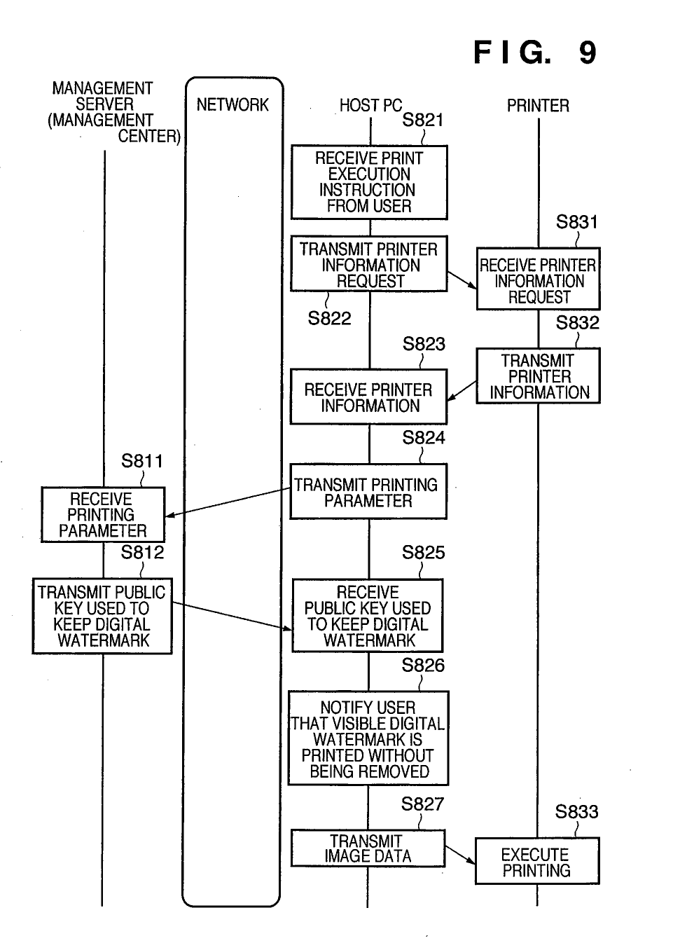

FIG. 9 shows the print sequence executed when the printing parameters set in the printer 720 do not match the values pre-set in the copyright image 712, and print processing is executed while the visible digital watermark remains unremoved. In FIG. 9, the same sequence as that up to step S711 shown in FIG. 8 is executed until the management server 600 receives the printing parameters of the printer 720 from the host PC 710 (steps S821, S822, S831, S832, S823, S824, and S811). Therefore, a description of steps S821, S822, S831, S832, S823, S824, and S811 will not be given.

Referring to FIG. 9, upon reception of the printing parameters of the printer 720 in step S811, the management server 600 checks if the printing parameters match settings that the copyright holder intended. At this, if at least one printing parameter does not match the contents of the limited parameter information 602, the management server 600 does not permit execution of print processing of an original image, and sends a public key 604 used to remain the digital watermark unremoved to the host PC 710 in step S812.

Upon reception of the public key 604 from the management server 600 in step S825, the host PC 710 notifies the user that the visible digital watermark is printed without being removed in step S826. If the user agrees that the visible digital watermark is printed without being removed, the host PC 710 transmits the copyright image 712 embedded with the visible digital watermark, i.e., the image data 601 appended with the visible digital watermark information 602 to the printer 720 in step S827. The printer 720 prints the copyright image 712 with the visible digital watermark received from the host PC 710 in step S833. If the user does not agree that the visual digital watermark is printed without being removed in step S826, the print processing in step S827 and subsequent steps is aborted.

In the third embodiment, verification and removal of the corresponding visible digital watermark can be independently executed for a plurality of printing parameters as in the second embodiment. In this case, public keys must be prepared in correspondence with the printing parameters.

According to the third embodiment, since the image data to be sent does not include any printing parameter information, the same effects as in the first or second embodiment can be obtained for new printing parameters.

In the first to third embodiments, the user purchases a copyright image from the management server 600 at the host PC 710, and then prints it out. Also, these embodiments may be implemented as a system that charges a fee every time an image is printed.

In this case, when all the printing parameters match the settings that the copyright holder intended, and the visible digital watermark is removed, a charge counter can be counted up. Especially, in the third embodiment, at the time of sending the public key 604 required to remove the digital watermark, the charge counter can be counted up.

Upon implementing such charge system, the user may consider the purchase of a copyright image provided by the management server 600 after he or she executes draft print processing of that copyright image. For example, the user downloads a copyright image provided by the management server 600 at the host PC 710, and executes draft print processing with low image quality using the printer 720. With the draft print processing, since some printing parameters do not match the settings that the copyright holder intended, an image embedded with the visible digital watermark is printed out. At this time, since the visible digital watermark is embedded in a region which is relatively not important in an image (the background region in FIG. 2B or 4B), the user can see about the important region (principal region) of the image in detail even on the draft printout, and can determine whether or not to purchase that copyright image.

In the first to third embodiments, the printer 720 is locally connected to the host PC 710. However, the printer used in print processing is not limited to the local printer but may be a printer on the network.

As described above, according to the present invention, an image can be printed while a visible digital watermark can be removed when the print settings reflect the intention of the copyright holder. On the other hand, an image appended with a visible digital watermark is printed when the print settings do not reflect the intention of the copyright holder. In this way, an image of value as a work of art is printed to have settings that the copyright holder intended. Even upon printing such image in a print service or the like, an image can be prevented from being printed with print settings different from those that the copyright holder intended on purpose or accidentally.

When the user wants to print a draft image, an image is printed to allow the user to recognize that it is a draft image. In other words, the user can use a draft image printed on a medium in decision of the purchase. Such sample print is required since the impression of an image on the display screen is different from that formed on the medium. It is particularly effective to allow such sample print when an expensive medium is used or when an image is printed using a large-format printer.

Upon practicing the present invention, the following system can also be implemented. A digital content whose visible digital watermark is removed only when it is printed using a special medium is created, and is distributed at a low price or without any fee. Upon printing such digital content as per normal, the image is embedded with a visible digital watermark. Therefore, the user must purchase the special medium to print the image while removing the visible digital watermark. Hence, such new business model is viable.

The present invention can adopt embodiments in the forms of a system, apparatus, method, program, storage medium (recording medium), and the like. More specifically, the present invention can be applied to either a system constituted by a plurality of devices (e.g., a host computer, interface device, image sensing device, Web application, and the like), or an apparatus consisting of a single device.

Note that the present invention can also be achieved by directly or remotely supplying a program of software that implements the functions of the above embodiments to a system or apparatus, and reading out and executing the supplied program code by a computer of that system or apparatus. The program in this case is that corresponding to each illustrated flowchart in the embodiments.

Therefore, the program code itself installed in a computer to implement the functional processing of the present invention using the computer implements the present invention. Put differently, the present invention includes the computer program itself for implementing the functional processing of the present invention.

In this case, the form of program is not particularly limited, and an object code, a program to be executed by an interpreter, script data to be supplied to an OS, and the like may be used as long as they have the functions of the program.

As a recording medium for supplying the program, the following media can be used. For example, a floppy® disk, hard disk, optical disk, magneto-optical disk, MO, CD-ROM, CD-R, CD-RW, magnetic tape, nonvolatile memory card, ROM, DVD (DVD-ROM, DVD-R), and the like can be used.

As a program supply method, the following method may be used. The user establishes a connection to a home page on the Internet using a browser on a client computer, and downloads the computer program itself of the present invention (or a compressed file including an automatic installation function) from the home page onto a recording medium such as a hard disk or the like. Also, the program code that forms the program of the present invention may be segmented into a plurality of files, which may be downloaded from different home pages. In other words, the present invention includes a WWW server which makes a plurality of users download a program file required to implement the functional processing of the present invention by the computer.

Also, a storage medium such as a CD-ROM or the like, which stores the encrypted program of the present invention, may be delivered to the user, and the user who has cleared a predetermined condition may be allowed to download key information used to decrypt the encrypted program from a home page via the Internet. The user executes the encrypted program using the downloaded key information to install the program on a computer.

The functions of the above embodiments can be implemented when the computer executes the readout program. Furthermore, the functions of the above embodiments can be implemented when an OS or the like running on the computer executes some or all of actual processing operations on the basis of an instruction of that program.

Furthermore, the functions of the above embodiments can be implemented when the program read out from the recording medium is written in a memory equipped on a function expansion board or a function expansion unit, which is inserted in or connected to the computer, and is then executed. Therefore, a CPU equipped on the function expansion board or function expansion unit can execute some or all of actual processing operations.

According to the present invention, image data can be reliably printed under ideal printing conditions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-174452 filed on Jun. 23, 2006, which is hereby incorporated by reference herein in its entirety.

What is claimed is:

1. An image processing system in which a management server, a host computer, and a printer are connected via a network, and said host computer prints image data received from said management server based on a printing parameter indicating a printing condition set by a user using said printer,
wherein said host computer receives image data appended with a visible digital watermark from said management server, detects a printing parameter set in said printer, collates the detected printing parameter with a limited parameter which is set in advance for the image data, and removes the visible digital watermark from the image data in accordance with a collation result.

2. The system according to claim 1, wherein said host computer receives image data including the visible digital watermark and the limited parameter, and collates the printing parameter with the limited parameter included in the image data.

3. The system according to claim 1, wherein the printing parameter and the limited parameter have a plurality of types of common printing conditions, and
said host computer receives image data appended with visible digital watermarks corresponding to respective printing conditions, and removes the visible digital watermark for each printing condition whose collation result indicates a match.

4. The system according to claim 1, wherein said host computer requests said printer to return print setting information, and detects the printing parameter based on the print setting information returned from said printer in response to the request.

5. The system according to claim 1, wherein said management server charges a fee when the visible digital watermark is removed from the image data.

6. The system according to claim 1, wherein the visible digital watermark is embedded in a non-principal region in the image data.

7. The system according to claim 1, wherein the visible digital watermark is embedded in a principal region in the image data.

8. The system according to claim 1, wherein the visible digital watermark indicates contents of the limited parameter.

9. The system according to claim 1, wherein the image data is copyrighted image data.

10. An image processing system in which a management server, a host computer, and a printer are connected via a network, and said host computer prints image data received from said management server based on a printing parameter indicating a printing condition set by a user using said printer,
wherein said host computer receives image data appended with a visible digital watermark from said management server, detects a printing parameter set in said printer, and sends the detected printing parameter to said management server,
said management server collates the printing parameter received from said host computer with a limited parameter which is set in advance for the image data, and transmits a public key required to remove the visible digital watermark to said host computer in accordance with a collation result, and
said host computer removes the visible digital watermark from the image data using the public key received from said management server.

11. The system according to claim 10, wherein said management server collates the printing parameter with the limited parameter held in said management server.

12. The system according to claim 10, wherein the printing parameter and the limited parameter have a plurality of types of common printing conditions, and
said host computer receives image data appended with visible digital watermarks corresponding to respective printing conditions, and removes the visible digital watermark for each printing condition whose collation result indicates a match.

13. The system according to claim 10, wherein said host computer requests said printer to return print setting information, and detects the printing parameter based on the print setting information returned from said printer in response to the request.

14. The system according to claim 10, wherein said management server charges a fee when the visible digital watermark is removed from the image data.

15. The system according to claim 10, wherein said management server charges a fee when the public key is transmitted.

16. The system according to claim 10, wherein the visible digital watermark is embedded in a non-principal region in the image data.

17. The system according to claim 10, wherein the visible digital watermark is embedded in a principal region in the image data.

18. The system according to claim 10, wherein the visible digital watermark indicates contents of the limited parameter.

19. The system according to claim 10, wherein the image data is copyrighted image data.

20. An image processing method for printing image data based on a printing parameter indicating a printing condition set by a user, said image processing method comprising the steps of:
inputting image data appended with a visible digital watermark;
detecting the printing parameter;
collating the detected printing parameter with a limited parameter which is set in advance for the image data; and
removing the visible digital watermark from the image data in accordance with a collation result.

21. The method according to claim 20, wherein the printing parameter and the limited parameter have a plurality of types of common printing conditions,
the image data input in the inputting step is appended with visible digital watermarks corresponding to the printing conditions, and
the visible digital watermark is removed for each printing condition whose collation result indicates a match in the watermark removing step.
